(19) United States
(12) Patent Application Publication
(10) Pub. No.: US 2017/0364687 A1
(43) Pub. Date: Dec. 21, 2017

(54) SEALED NETWORK INITIALIZATION

(71) Applicant: Lior Malka, San Jose, CA (US)

(72) Inventor: Lior Malka, San Jose, CA (US)

(21) Appl. No.: 15/186,440

(22) Filed: Jun. 18, 2016

(51) Int. Cl. G06F 21/60; H04L 29/06; G06F 9/445; G06F 17/30

(52) U.S. Cl. CPC G06F 21/602; G06F 17/30345; H04L 63/0876; G06F 8/61; H04L 2209/16; G06F 2221/2107

(57) ABSTRACT

Embodiments are provided for initializing a sealed network. A sealed network does not require administrators and may run on hardware and software that has been stripped of privileged capabilities. In one embodiment, an obfuscator generates a root, which is the first instance of a sealed network, and the root presents a control panel allowing an authorized operator to further guide the network. In one embodiment, a new instance is added to a sealed network via the control panel. In one embodiment, a unique identifier is found in a network.

### BACKGROUND

Existing networks require an administrator. An administrator has privileged capabilities for managing remote devices. For example, installing or uninstalling software, creating or deleting or editing or viewing files including operating system files, adding or removing users, changing passwords, remote access, and so on. Due to their nature, networks that require administrators are more expensive, more complicated, less secure, and less reliable compared to networks that have no administrators.

### SUMMARY

Embodiments are provided for initializing a sealed network. A sealed network does not require administrators and may run on hardware and software that has been stripped of privileged capabilities. In one embodiment, an obfuscator generates a root, which is the first instance of a sealed network. Any obfuscator may be used. The root installs on its first launch. The root presents a control panel allowing an authorized operator to further guide the network. In one embodiment, a new instance is added to a sealed network via the control panel of an existing root. The instance is a root or a node, and is generated using an obfuscator. Any obfuscator may be used. In one embodiment, a unique identifier is found in a network.

### DRAWINGS

The following figures illustrate the embodiments by way of example. They do not limit their scope.

FIG. 1 shows a flow diagram of a method of initializing a sealed network, in accordance with one embodiment.

FIG. 2 shows a flow diagram of a method of adding root or node instances to a sealed network, in accordance with one embodiment.

FIG. 3 shows a flow diagram of a method of finding a unique identifier in a network, in accordance with one embodiment.

### DETAILED DESCRIPTION

This section includes detailed examples, particular embodiments, and specific terminology. These are not meant to limit the scope. They are intended to provide clear and through understanding, cover alternatives, modifications, and equivalents.

A network is a collection of devices. Each device has zero or more parties executing on it. Each party has a unique identifier. A Party may be multithreaded, and each thread may be communicating with other parties using an address. The parties that communicate with a party are the neighbors of that party. Communication channels may be secure or not or both.

A sealed network is a network that does not require administrators. An administrator is an entity with privileged capabilities for managing remote devices. These capabilities include remote access, database access, superuser accounts, and so on. A sealed network has an operator. An operator does not have privileged capabilities. Rather, the sealed network provides a control panel, and the operator, after providing credentials, uses the control panel to guide the network. Any credentials, such as a username and a password, may be used.

A party that provides a control panel is called a root. A party for general purpose applications is a server. A party that controls servers is a node. A device may have any number of roots, nodes, and servers. Parties may run on hardened environments, and may further harden the environment as they execute. Hardening involves configuring or redesigning so that privileged capabilities are eliminated or are inaccessible. All parties may be obfuscated. The obfuscated code is called an instance. An instance is generated by providing randomness and instance inputs to an obfuscator, and compiling the obfuscator output. All instances may have files or databases that are protected, fully or partially, with cryptographic functions, such as encryption, signatures, and signcryption. The description of those functions and their keys may also be protected using a cryptographic function that is obfuscated in the instance.

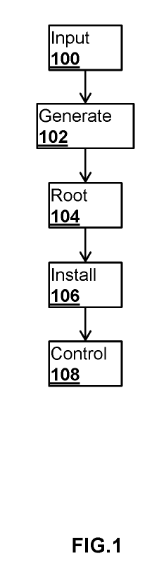

FIG. 1 shows a flow diagram of a method of initializing a sealed network, in accordance with one embodiment. The input 100 includes operator credentials, database credentials, and an address for communicating with other parties. A unique identifier for the root may also be included if the default is not desired. The input and the root logic is obfuscated and compiled to generate 102 an executable root 104. Any obfuscation method may be used. The executable root may have a protected file containing the input. When the executable root is launched, it installs 106 and displays a control panel 108. It also uses the address from the input to attach to the network. Hence, a sealed network with one party has been created. The operator may use the operator credentials to access the control panel.

Any installation method may be used. For example, the root may use the database credentials from the input to create a new database account, and then remove the credentials from the database. The root may also move the data from the protected file into the database, and then delete the file. It may also create a new protected file to store the new database account credentials.

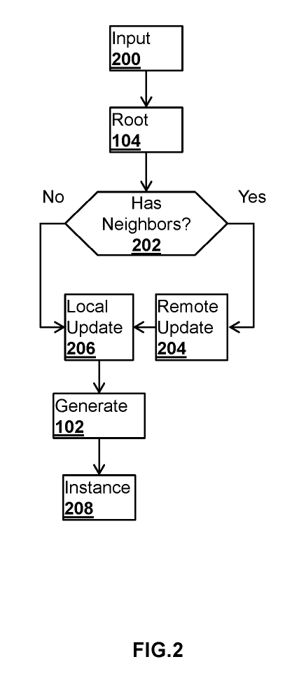

FIG. 2 shows a flow diagram of a method of adding root or node instances to a sealed network, in accordance with one embodiment. Input 200 is provided by an operator via the control panel of a first root 104. If the instance being added is a second root, then the input includes an identifier, database credentials, and an address. If the instance is a node, then, in addition, a second root identifier is included to indicate that the node is attached to the second root. The second root and the first root may be identical.

If the first root has no neighbors 202, then it performs a local update 206 to its database tables, and generates 102 a new instance 208 which is either a root or a node. The new instance is outputted. Otherwise, the first root performs a remote update 204 where it requests all other roots to update their tables with the identifier from the input. If a neighbor cannot determine that the identifier is unique, then it fails. If all neighbors are successful, then the first root performs a local update and generates the new instance. The new instance, when launched, joins the network.

If the instance being added is a root, then the first root performs the local update and generates a root instance. A local update by a party includes adding an account that would allow the party and the instance to communicate. It also includes adding the address and the identifier, which are part of the input. An error occurs if the identifier is not unique. The instance may have a protected file that includes Information from the input, such as the database credentials, as well as from the local update, such as the account that would allow the party and the instance to communicate.

If the instance being added is a node, then the first root forwards the request to a second root whose identifier is in the input. As mentioned above, the second root and the first root may be identical. The second root performs a remote update, and if all neighbors are successful, it performs a local update and generates a new node instance.

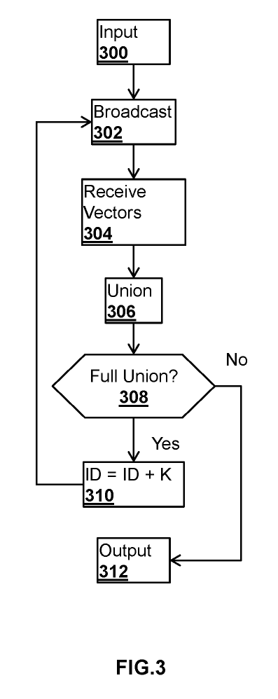

FIG. 3 shows a flow diagram of a method of finding a unique identifier in a network. Any network may be used. Any identifier may be used, such as a number from a column of serial numbers in a database table. The input 300 describes the identifier and the start value ID. For example, a table name and a column name may describe the identifier, and zero may be the start value. The identifier may not be a numeric value. Any enumerable type whose elements can be iterated over can be used.

The identifier and a range [ID, ID+K] is broadcast 302 to all parties with sets of identifiers, where K may be fixed or modified during execution. Each party replies with membership of elements in the range [ID, ID+K]. Any method for representing sets may be used. For example, the parties may reply with a vector of zeroes and ones. The j-th position in the vector has one if and only if the value represented by ID+j is in the set.

The vectors are received 304, and their union 306 is computed. The union may be represented using a vector. The j-th position in the union has one if at least one of the vectors has one in the j-th position. The union is full if all positions are one. If the union is full 308, then ID is incremented by K 310, and the method repeats. To complete a full cycle, ID may be incremented past its upper bound, to continue from its lower bound, and an error may occur if no unique ID has been found after a complete cycle. If the union is not full, then ID+j is outputted 312, where j is any position in the union, such as the first one, that has zero.

A vector describing a range may be represented in any way. For example, it may include ID and a byte array representing a sequence of bits. The vector may be shrunk using any compression method. If K=0, then the vector can be replaced with a Boolean value. The union may be computed in any way and may not be represented by a vector. The method may be multithreaded, so that several copies of the method are executing concurrently, each covering a range of possibly disjoint ID values.

What is claimed is:

1. A method of initializing a sealed network, the method comprising:
receiving input including operator credentials, database credentials, and an address; and
generating a root using the input and a root logic; and
launching the root to install and present a control panel for an operator.

2. The Method of claim 1, wherein generating a root using the input and a root logic uses an obfuscator that protects files of the root using a cryptographic function that is obfuscated in the root code.

3. The Method of claim 1, wherein the installation creates a new database account for the root.

4. The Method of claim 1, wherein the installation moves data from files of the root to a database.

5. The Method of claim 1, wherein installation removes the database credentials.

6. The Method of claim 1, further comprising removing installation files from the root after successful installation.

7. The Method of claim 1, further comprising a hardening of the execution environment.

8. The Method of claim 1, wherein invalid credentials and addresses trigger an error.

9. A method of adding root or node instances to a sealed network, the method comprising:
receiving input including an identifier, database credentials, an address, and an identifier of a second root if the instance being added is a node; and
performing a local update and a remote update, the update adds the identifier and fails if the identifier is not unique, the local update is on the first root if adding a root instance and on the second root if adding a node instance; and
generating an instance from the input, update information, and instance logic; and
outputting the instance.

10. The method of claim 9, wherein generating an instance from the input, update information, and instance logic uses an obfuscator that protects files of the instance using a cryptographic function that is obfuscated in the instance code.

11. The method of claim 9, further comprising switching the first root to a listen mode, waiting for the instance to establish a connection, and reverting to a no listen mode.

12. The method of claim 9, further comprising launching the instance from one of the network devices.

13. A method of finding a unique identifier in a network, the method comprising:
receiving input containing an identifier, a start value ID, and a number K; and
broadcasting the identifier and [ID, ID+K] to all parties with sets of identifiers; and
receiving from each party a vector representing membership of elements in the range [ID, ID+K] in the party's set; and
outputting an element not found in any of the vectors if such an element exists and otherwise repeating with ID=ID+K.

14. The Method of claim 13, wherein ID is incremented until all values has been traversed, and an error is thrown if no unique identifier has been found.

15. The Method of claim 13, wherein ID is replaced with an iterator over ranges of identifiers.

16. The Method of claim 13, wherein K=0, and [ID, ID+K] is replaced with ID, and vectors are replaced with a Boolean value.

17. The Method of claim 13, wherein the vector is represented using a byte array.

18. The method of claim 13, wherein broadcasting the input to all parties with sets of identifiers is done by a separate thread per party.

19. The Method of claim 13, wherein the vector is compressed.
